(19) United States
(12) Patent Application Publication
(10) Pub. No.: US 2006/0004871 A1
(43) Pub. Date: Jan. 5, 2006

(54) Multimedia data reproducing apparatus and multimedia data reproducing method and computer-readable medium therefor

(75) Inventors: Hiroko Hayama, Tokyo (JP); Masaru Suzuki, Kanagawa (JP); Mika Fukui, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/165,285

(22) Filed: Jun. 24, 2005

(30) Foreign Application Priority Data
Jun. 30, 2004 (JP) 2004-192393

(51) Int. Cl. G06F 17/00

(52) U.S. Cl. 707/104.1

(57) ABSTRACT

A playback control portion controls a playback of multimedia data. A request acceptance portion accepts a question from the user. A playback position storage unit stores the playback position of multimedia data reproduced by the playback control unit at the point of time when the question was accepted from the user. An analyzing unit analyzes the question accepted by the request acceptance unit. A searching unit searches for an answer to the question on the basis of analysis information of the multimedia data by using a result of searching. The playback control portion outputs the answer thus searched for. A position comparing unit compares the position of appearance of the answer in the multimedia data corresponding to the answer with the playback position stored in the playback position storage device. The playback position changing portion changes the playback position of the multimedia data in accordance with a result of the comparison.

### CROSS-REFERENCE TO RELATED APPLICATIONS

This application is based upon and claims the benefit of priority from the prior Japanese Patent Application No. 2004-192393, filed on Jun. 30, 2004; the entire content of which is incorporated herein by reference.

### BACKGROUND OF THE INVENTION

1. Field of the Invention

The present invention relates to a multimedia data reproducing apparatus for reproducing multimedia data such as video, audio, etc.

2. Description of the Related Art

Use of relatively large-capacity multimedia contents such as video, audio, etc. on a network has recently increased with the advance of increase in network speed. Contents using video have been used in e-learning as well as distribution of music data, news video, etc. Digitizing contents such as start of digital terrestrial broadcasting has advanced in the broadcasting field.

In the digitized multimedia contents, various information can be added to all or a part of contents.

For example, a title and cast names can be added to all contents of a drama, a movie or the like or time information, scene titles, etc. can be added to scene breaks. The information added to contents is generally called “meta-information”. For example, movie contents using DVD as a medium are generally virtually divided by chapters. When one chapter is selected from a list of chapters, the movie contents can be easily reproduced from the head of the desired chapter. The meta-information added to the contents can be used for retrieving the contents etc.

For example, in a “Streaming System and Streaming Program” described in JP-A-2003-259316, meta-information (text data) is added to a partial stream which is a part of a stream. A keyword given by a user is used for retrieving meta-information. The user can specify a desired partial stream in accordance with a result of the retrieval so that the partial stream can be reproduced.

On the other hand, when a technique of extracting information from a text is used, the document retrieval obtained is different from simple document retrieval. That is, there is known a technique of extracting a portion suitable for an answer to a question from retrieved documents (e.g. see JP-A-2002-132812 “Question and Answering Method, Question and Answering System and Recording Media with Question and Answering Program Recorded”). For example, to the question “How high is Mt. Fuji?”, a portion “3776 m” in retrieved documents is extracted as an answer to the question as well as documents containing words contained in “How high is Mt. Fuji?” are retrieved.

If such an information extraction technique is used, only a portion estimated to be an answer to the question the user wants to know can be extracted from a large deal of documents. Accordingly, the user's labor for retrieving a portion corresponding to an answer to the question while displaying documents as a result of the retrieval at the time of document retrieval can be saved. In this technique, if the user makes a question “What grams of sugar?” when the user wants to confirm the amount of sugar in the condition that the user is cooking while looking a recipe for cooking, a portion concerned with the amount of sugar can be extracted as an answer from a recipe portion having already read.

However, when video data is to be reproduced from the middle between predetermined units such as chapters, there is no effective means for specifying a desired position between chapters. When video data is to be reproduced from a desired position between chapters as described above, it is necessary to jump the playback position to a chapter nearest to a desired playback position and make fast forwarding or rewinding manually until the playback position reaches the desired position from the jumped position. For example, when the user is learning in the form of e-learning by using video data, the user may often want to confirm a part of another topic learned in the past or a portion slightly before the currently reproduced contents. In this case, it is difficult to reproduce the portion that the learner wants to watch once more if only topics prepared in advance are provided. It is necessary to start a playback from the head of a topic including the portion to watch and performing fast forwarding or rewinding to the target place while confirming arrival at the portion by eye observation. Such a situation may occur not only in video contents but also in voice data of conference minutes. If the user wants to confirm the contents of slightly previous speech while recorded data of conference minutes is reproduced, the operation of fast forwarding or rewinding recorded data must be repeated until it comes to the speech portion.

To solve this problem, for example, in the “Streaming System and Streaming Program” in Patent Document 3, retrieval and reproduction of a partial stream including a keyword can be made.

### SUMMARY OF THE INVENTION

In JP-A-2003-259316, it is however impossible to give top priority to the stream “slightly before the currently watched portion” in consideration of the current playback position information of the stream at the time of retrieval.

The learner can obtain an answer per se to be confirmed if the information extraction technique is used for specifying the portion to be confirmed by retrieval.

In the information extraction technique according to the background art, there is however no consideration of multimedia data such as video because text documents are a subject of retrieval.

It is an object of the invention to provide a multimedia data reproducing apparatus in which a result of retrieval of multimedia data and a current playback position of the multimedia data are used for specifying a place (e.g. a place that a user wants to confirm once more) estimated to be requested by the user from the user's question so that the multimedia can be reproduced after the playback position is jumped to the specified place of the multimedia data.

To achieve the foregoing object, according to one aspect of the invention, there is provided with a multimedia data reproducing apparatus including: a playback control unit that controls reproduction of multimedia data from a plurality of media; a question acceptance unit that accepts a question from a user; a playback position storage unit that stores a playback position of the multimedia data reproduced by the playback control unit when the question acceptance unit accepts the question from the user; an analyzing unit that analyzes the question accepted by the question acceptance unit; a searching unit that retrieves an answer to the question from analysis information of the multimedia data by using an analysis result of the analyzing unit; an output unit that outputs the answer retrieved by the searching unit to present the answer to the user; a position comparing unit that compares an answer appearance position of the multimedia data corresponding to the answer retrieved by the searching unit with the playback position stored by the playback position storage unit; and a playback position changing unit that makes the playback control unit change the playback position of the multimedia data in accordance with a comparison result of the position comparing unit.

To achieve the foregoing object, according to another aspect of the invention there is provided with a multimedia data reproducing method including: making a playback control unit control reproduction of multimedia data from a plurality of media; accepting a question from a user; storing a playback position of the reproduced multimedia data when the question is accepted from the user; analyzing the accepted question; retrieving an answer to the question from analysis information of the multimedia data on the basis of an analysis result; outputting the retrieved answer to present the answer to the user; comparing an answer appearance position of the multimedia data corresponding to the retrieved answer with the stored playback position; and making the playback control unit change the playback position of the multimedia data in accordance with the comparison result.

According to another aspect of the invention, a place estimated to correspond to the user's request can be specified by retrieval during the playback of multimedia data so that the playback position of the multimedia can be made jump to the specified place and reproduced. Accordingly, the user can save the labor of searching for the place required to be reproduced from the multimedia data, so that user-friendliness is improved.

### BRIEF DESCRIPTION OF THE DRAWINGS

FIG. 1 is a diagram showing an example of the form of use of a multimedia data reproducing apparatus according to one embodiment of the invention;

FIG. 2 is a functional block diagram for explaining the configuration of the multimedia data reproducing apparatus according to one embodiment of the invention;

FIG. 3 is a functional block diagram for explaining the configuration of the multimedia data reproducing apparatus according to one embodiment of the invention;

FIG. 4 is a diagram showing an example of speech contents of video data 104;

FIG. 5 is a diagram showing speech text data in which the speech portion of the video data 104 in FIG. 4 is provided as a text;

FIG. 6 is a diagram showing an example of analysis information obtained by analyzing the speech text data in FIG. 5;

FIG. 7 is a diagram showing an example of display of multimedia data based on a multimedia data search browsing program 200;

FIG. 8 is a diagram showing an example of display of multimedia data based on the multimedia data search browsing program 200;

FIG. 9 is a functional block diagram for explaining the configuration of the multimedia data reproducing apparatus according to second embodiment of the invention; and

FIG. 10 is a diagram showing an example of hardware in the case where the multimedia data reproducing apparatus is achieved by a computer.

### DESCRIPTION OF THE EMBODIMENTS

Embodiments of the invention will be described below in detail with reference to the drawings.

### First Embodiment

A first embodiment of the invention will be described below with reference to the drawings.

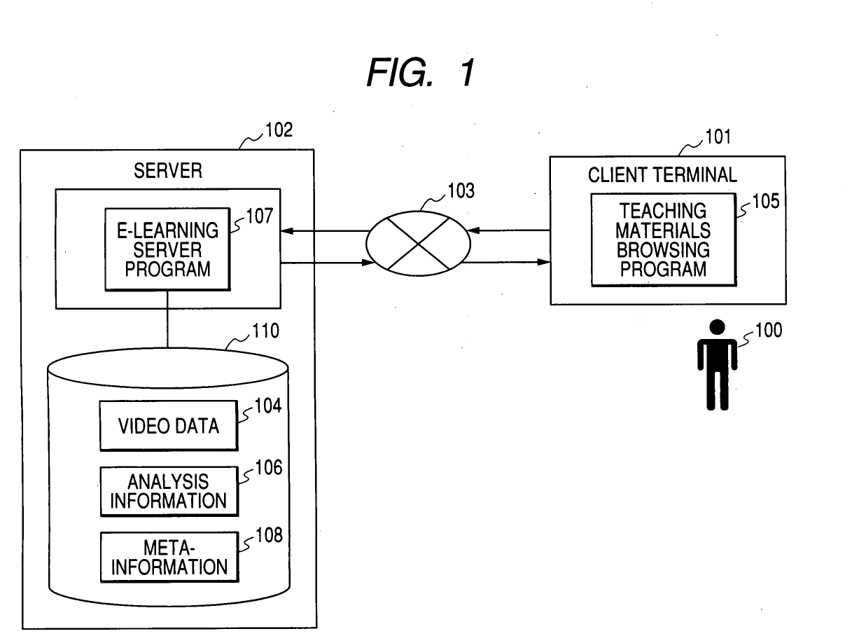

FIG. 1 is a diagram showing an example of mode in use of the invention. This embodiment shows the case where a multimedia data reproducing apparatus according to the invention is applied to an education system using e-learning.

In this specification, the term “multimedia data” means electronic data such as video, audio, text, etc. or meta-data as description of information required for reproducing these electronic data.

In FIG. 1, the multimedia data reproducing apparatus comprises a server 102 for e-learning system, and a client terminal 101 for accessing the server 102.

Incidentally, a teaching materials browsing program 105 and an e-learning server program 107 are executed by a computer. Although computer parts such as a processor, an ROM, an RAM, etc. for executing the programs are not shown in FIG. 1 because the computer parts are out of the gist of one embodiment of the invention, a general-purpose computer may be used. Each of the client terminal 101 and the server 102 is constituted by a computer having a processor, a memory, etc. not shown. For example, the client terminal 101 and the server 102 are connected to each other by the Internet 103.

A user 100 accesses the server 102 of the e-learning system by using the client terminal 101 to start an education curriculum for e-learning. On this occasion, the server 102 distributes teaching materials inclusive of video data 104 to the client terminal 101. The user 100 reads the teaching materials distributed from the server 102 by using the teaching materials browsing program 105 of the client terminal 101. In this specification, the term “video data” includes not only video data of motion picture but also voice-containing video data inclusive of motion picture and audio signal. This embodiment will be described on the case where voice-containing video data is taken as an example.

Assume now that the user 100 missed listening to an explanation such as “ZZ XXed in YY year.” in the video data 104. On this occasion, the user 100 makes a question such as “When did ZZ XX?” to the teaching materials browsing program 105 to check the missing portion. Text input from an input means such as a keyboard provided in the client terminal 101 may be used for inputting this question or voice input due to a microphone and a voice recognition function may be used for inputting this question.

A question sentence input by the user is transmitted from the client terminal 101 to the server 102 and processed by the e-learning server program 107 on the server 102. That is, a portion (e.g. “YY year” in this case) corresponding to the answer to the question is extracted from analysis information 106 corresponding to the video data 104 which is being browsed by the user 100. A portion of the video data 104 to which the extracted answer corresponds is further retrieved by use of information in the analysis information 106. The e-learning server program 107 distributes the answer to the question and the video data 104 from the position corresponding to the answer to the teaching materials browsing program 105 in the client terminal 101.

In the client terminal 101, the teaching materials browsing program 107 displays the answer from the server 102 and the video data 104 from the position corresponding to the answer.

Incidentally, the playback position of the video data 104 at the point of time when the user 100 made the question may be stored in a memory or the like in the client terminal or the server 102 so that the teaching materials including the video data 104 can be distributed again from the stored position of the teaching materials after the portion the user wants to check is reproduced. In this manner, the user's listening to the teaching materials can be restarted from the listening interrupt position of the teaching materials listened just before asking the question.

Incidentally, the multimedia data reproducing method according to one embodiment of the invention can be applied not only to the e-learning system but also to any other application including the operation of multimedia data. The mode of use is not limited to the mode described in this embodiment. For example, there may be used a mode in which all functions are mounted in the user side terminal.

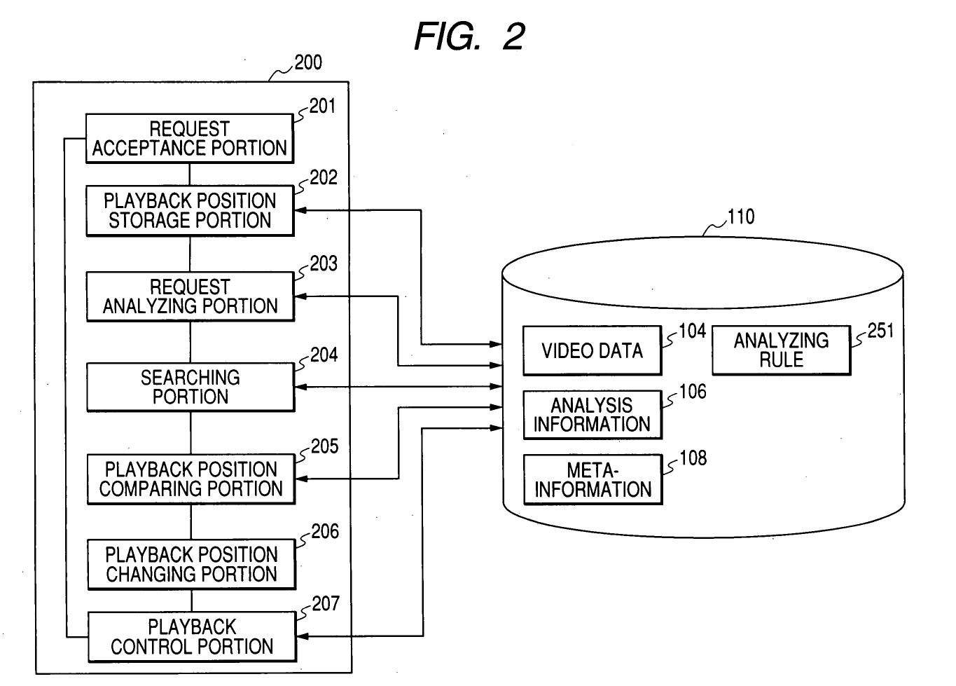

FIG. 2 is a functional block diagram for explaining the configuration of the multimedia data reproducing apparatus according to one embodiment of the invention.

Although computer parts used in one embodiment of the invention for executing the programs, such as a processor, an ROM, an RAM, etc. are not shown in FIG. 2 because the computer parts are out of the gist of one embodiment of the invention, a general-purpose computer may be used.

This embodiment shows the case where video data 104 and meta-information 108 and analysis information 106 corresponding to the video data 104 are downloaded from the server 102 in FIG. 1 to the client terminal side in advance so that all processes such as searching can be made on the client side. For example, a storage device 110 in FIG. 2 corresponds to a storage device 110 in FIG. 1, and a multimedia data search browsing program 200 in FIG. 2 corresponds to an e-learning server program 107 and the teaching materials browsing program 105 in FIG. 1.

In FIG. 2, the multimedia data search browsing program 200 includes a request acceptance portion 201, a playback position storage portion 202, a request analyzing portion 203, a searching portion 204, a playback position comparing portion 205, a playback position changing portion 206, and a playback control portion 207.

The playback control portion 207 performs processes such as (1) reading the video data 104 and the meta-information 108 (corresponding to the video data 104) stored in the storage device 110, (2) reproducing and displaying the video data 104 and the meta-information 108 corresponding to the video data 104, (3) controlling temporary stop at reproduction, and (4) presenting an answer.

The request acceptance portion 201 accepts a question sentence text as a user's question-form request concerned with the reproduced video data 104 and delivers the question sentence text to the request analyzing portion 203.

The playback position storage portion 202 stores the playback position of the video data 104 at the point of time when the question sentence text as a user's request was accepted by the request acceptance portion 201.

The request analyzing portion 203 analyzes the question sentence text as a user's request accepted by the request acceptance portion 201 and estimates the type of information requested by the question sentence in accordance with a rule stored in the analysis rule 251 stored in the storage device 110. When, for example, a question sentence text “When did ZZ XX?” is given, requested information is estimated to be information of date or time on the basis of the expression “When . . . ?”.

Then, the searching portion 204 extracts answer candidates described with respect to date or time and estimated to be related to another keyword of the question sentence (“ZZ” or “did . . . XX”) on the basis of the analysis information 106 in accordance with the type estimated by the request analyzing portion 203, for example, in accordance with information of date or time as the requested type of information. A plurality of answer candidates may be extracted. Information indicating the degree of confidence of an answer to the user's request may be added to each answer candidate.

Incidentally, the analysis information 106 is prepared by analyzing text data, for example, obtained by extracting a speech portion of the video data 104. Each word having a potential for an answer extracted from the text data and the information type of the word are associated with the playback position of the video data 104 where the word is spoken.

The playback position comparing portion 205 compares the position where each of the answer candidates extracted by the searching portion 204 appears in the video data 104 with the playback position stored in the playback position storage portion 202. Incidentally, data recorded in the analysis information 106 is used as correspondence between each answer candidate and the appearance position of the answer candidate in the video data 104.

The playback position changing portion 206 selects one from the answer candidates as a searching result of the searching portion 204. For example, the playback position changing portion 206 selects an answer candidate which was former than the playback position of the video data 104 at the point of time when the request was accepted by the request acceptance portion 201 and which corresponds to a position nearest to the playback portion. The selected answer and position information in the video data 104 included in the answer are delivered to the playback control portion 207.

The playback control portion 207 reproduces the video data 104 from a position corresponding to the position information received from the playback position changing portion 206 and presents the answer to the question.

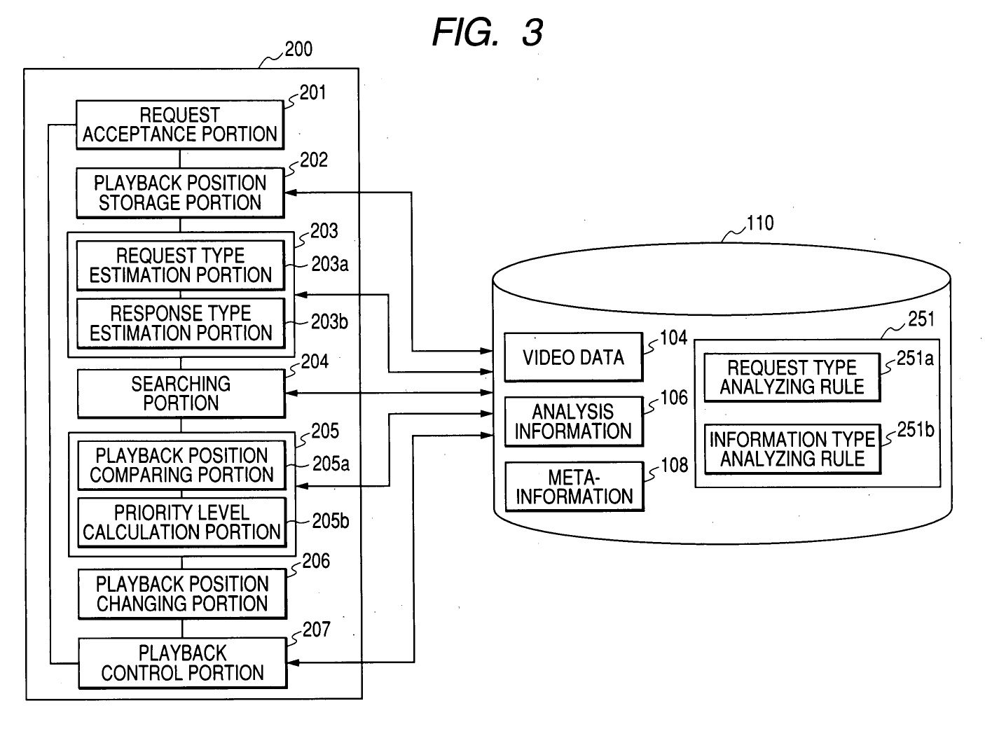

Next, the configuration of the request analyzing portion 203 and the playback position comparing portion 205 in FIG. 2 will be described in more detail with reference to FIG. 3 which is a functional block diagram.

FIG. 3 is a functional block diagram showing an example of more detailed configuration of the request analyzing portion 203 and the playback position comparing portion 205.

In FIG. 3, the request analyzing portion 203 includes a request type estimating portion 203a, and an answer type estimating portion 203b. The playback position comparing portion 205 includes a playback position comparing portion 205a, and a priority level calculation portion 205b. The analysis rule 251 includes a request type analyzing rule 251a, and an information type analyzing rule 251b.

The request type estimating portion 203a analyzes the question sentence accepted by the request acceptance portion 201 in terms of morphemes and estimates the request type of the question sentence from a pattern such as “When” or “Who” intended by the question. The request type analyzing rule 251a stored in the storage device 110 is used for the estimation of the request type.

The request type analyzing rule 251a expresses the aforementioned characteristic expression pattern such as “When” or “Where” intended by the question and a description of correspondence between the pattern and the request type defined in advance in accordance with the pattern. For example, “How”, “What”, “When”, etc. is defined as the request type. When there is nothing matched with the pattern of the request type analyzing rule 251a, the request type may be not assigned.

The answer type estimating portion 203b estimates the type of information as an answer to the question by using the information type analyzing rule 251b stored in the storage device 110 on the basis of the request type estimated by the request type estimating portion 203a. The information type expresses the type of information estimated to be an answer required by the question sentence as a subject of analysis. For example, “length”, “weight”, “person”, “country”, “year”, etc. is defined as the information type in advance. Several information types analogous to one another are put in one category. For example, “year”, “date”, “time interval”, etc. may be put in a category “time”.

The information type analyzing rule 251b includes a rule for correspondence between the request type and the category (of the information type), and a rule for correspondence between the typical expression pattern in the question sentence in accordance with each category and the information type. A plurality of categories may correspond to one request type.

The answer type estimating portion 203b first uses the request type-category correspondence rule to specify a category or categories in which the request type estimated by the request type estimating portion 203a will be put.

Then, the answer type estimating portion 203b uses the rule of the specified category or categories to estimate the information type from the expression pattern in the question sentence. A plurality of information types may be obtained here.

The searching portion 204 searches for answer candidates fitted to the information type estimated by the answer type estimating portion 203b.

Then, the playback position comparing portion 205a compares the playback position of the video data 104 corresponding to each answer candidate obtained by the searching portion 204 with the playback position stored in the playback position storage portion 202 as to the distance between the two playback positions.

Information prepared by analyzing the contents of the video data 104 is described in the analysis information 106 stored in the storage device 110.

As described above, for example, the analysis information 106 is prepared by analyzing text data obtained by extracting a speech portion of the video data 104. A word which may be an answer extracted from the text data and the information type of the word are associated with the playback position of the video data 104 where the word is spoken.

The searching portion 204 uses the analysis information 106 and the information type estimated by the request analyzing portion 203, for example, to extract answer candidates which agree with the estimated information type and which are highly relevant to the keyword in the question sentence, on the basis of the analysis information 106. Position information of the video data 104 corresponding to each answer candidate is added to the answer candidate.

Accordingly, the playback position comparing portion 205a can compare the playback position of each answer candidate in the video data 104 with the playback position stored in the playback position storage portion 202 to thereby calculate the degree of nearness of the playback position of each answer candidate to the stored playback position. For example, a reciprocal of the absolute value of the time difference between the playback position stored in the playback position storage portion 202 and the playback position of each answer candidate in the video data 104 is regarded as a score of the answer candidate. In this case, the score becomes higher as the answer candidate becomes nearer to the playback position of the video data 104 at the time of acceptance of the request.

Then, the priority level calculation portion 205b calculates the priority level of each of the answer candidates obtained by the searching portion 204. In this embodiment, the score which has been already calculated by the playback position comparing portion 205a is directly used as the priority level. Various priority level calculating means may be conceived in this embodiment. For example, the score calculated by the searching portion 204 and expressing the degree of confidence of an answer other than information described in the analysis information 106 may be added to each answer candidate. In this case, the score calculated by the priority level calculation portion 205b may be corrected in consideration of the score calculated by the playback position comparing portion 205a so that the corrected score can be used as the priority level of each answer candidate.

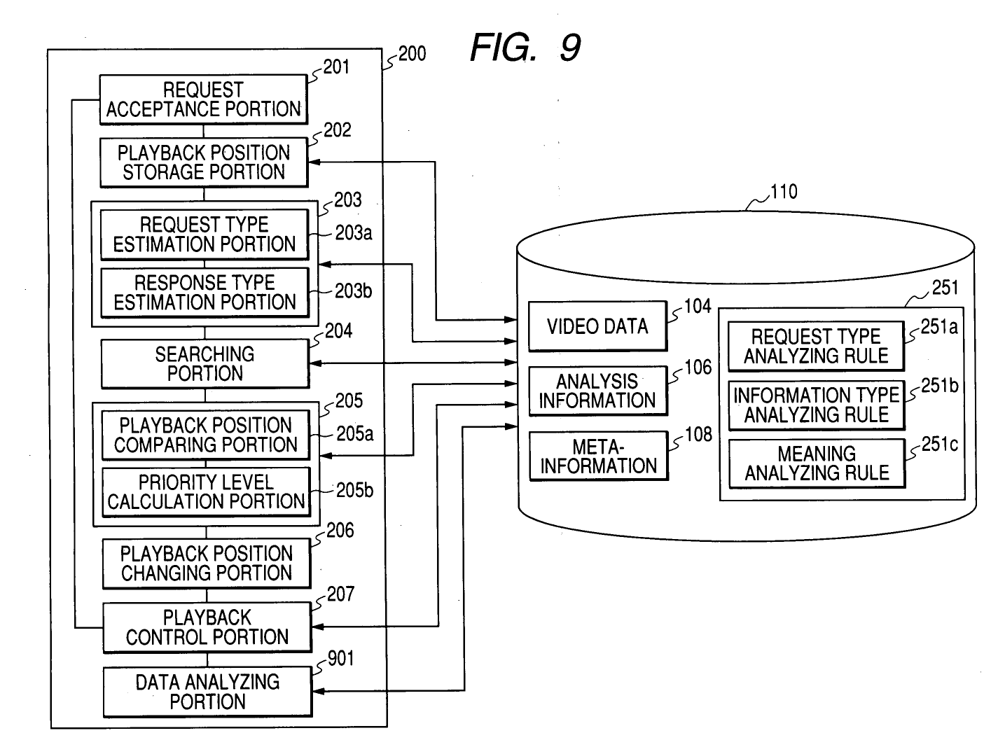

The playback position changing portion 206 selects an answer with the highest priority level calculated by the priority level calculation portion 205b from the answer candidates retrieved by the searching portion 204. The answer selected by the playback position changing portion 206 and the position corresponding to the selected answer in the video data 104 are delivered to the playback control portion 207, so that a playback of the video data starts from the position of the video data 104 corresponding to the answer. Incidentally, the method by which the playback position changing portion 206 selects the answer is not limited to the method described in this embodiment. For example, after the priority levels are calculated by the priority level calculation portion 205b, information may be delivered to the playback control portion 207 while all the answer candidates may be selected or a predetermined number of answer candidates may be selected in the descending order of priority level. In this case, the playback control portion 207 starts a playback of the video data 104 from the position corresponding to the answer with the highest priority level. As will be described later with reference to FIG. 9, the playback position may be switched to the position of the video data 104 corresponding to another answer in accordance with a user's instruction to display the next candidate.

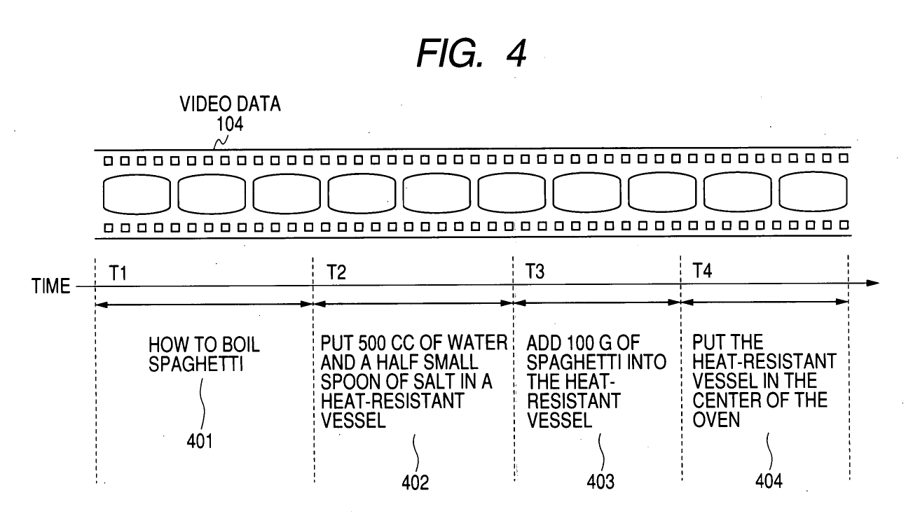

Next, examples of various data will be described in detail with reference to FIGS. 4 to 6.

FIG. 4 is a diagram showing an example of speech contents of the video data 104.

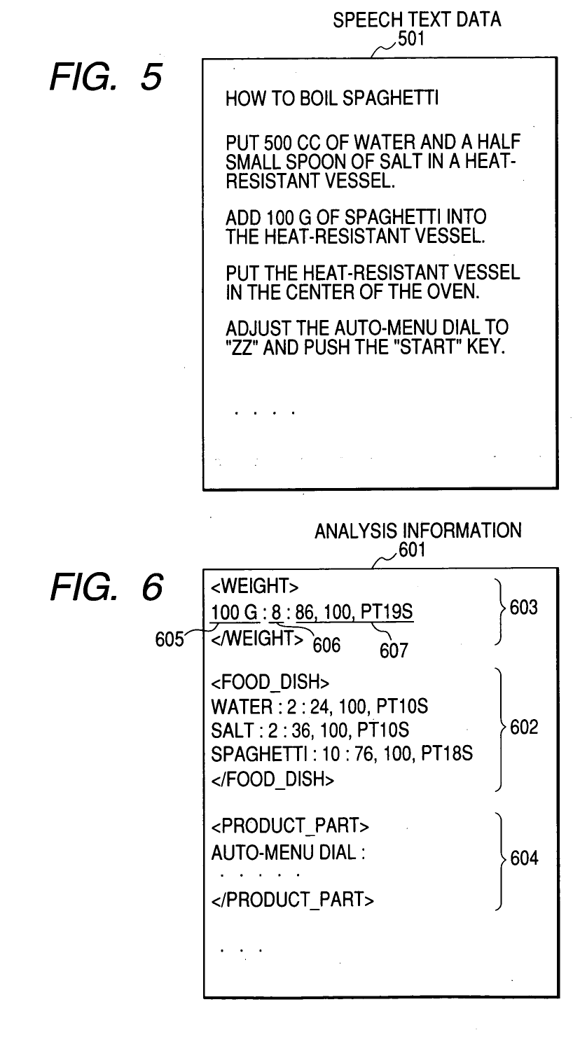

FIG. 5 is a diagram showing speech text data in which the speech portion of the video data 104 in FIG. 4 is provided as a text.

FIG. 6 is a diagram showing an example of analysis information obtained by analyzing the speech text data in FIG. 5.

How to boil spaghetti in an oven is explained in the video data 104 in FIG. 4. A state in which an explainer gives a demonstration of the procedure of boiling spaghetti in an oven is recoded in the video data 104. Each of the reference numerals 401 to 404 designates a part of the speech contents of the video data 104 which the explainer speaks.

In FIG. 5, speech text data 501 is formed in such a simple manner that the speech portion of the video data 104 in FIG. 4 is provided as a text. FIG. 5 shows an extracted part of the speech text data 501. The speech text data 501 is used for checking the degree of relation between each answer candidate and a keyword in the question sentence at the time of searching.

Analysis information 601 in FIG. 6 corresponds to the analysis information 106 in FIG. 2. The analysis data 601 is formed in such a manner that the speech text data 501 is analyzed in terms of morphemes and a meaning analyzing rule 251c in FIG. 9 is used for extracting (significant) words which may be used as the answer and the information types of the words from the words contained in the speech text data 501. For example, the uppermost element in FIG. 6, that is, information “100 g” with the information type “weight” is extracted from information “Put 100 g of spaghetti in a heat-resistant vessel” located in the neighbor of the center of the text in FIG. 5. Because appearance position information in the speech text data 501 is also extracted (as designated by the reference numeral 607), the sequence of appearance of the words in FIG. 6 need not be the same as the sequence of appearance of the words in FIG. 5.

The meaning analyzing rule 251c includes dictionary data in which correspondence between information types defined in advance and words belonging to each of the information types is described, and an analyzing rule by which “numeral+g (unit)” expresses “weight”.

In the example shown in FIG. 6, tags of “FOOD_DISH” (reference numeral 602) expressing food, “WEIGHT” (reference numeral 603) expressing weight and “PRODUCT_PART” (reference numeral 604) expressing part of product are described as information types. Portions enclosed in each pair of tags are a group of words which may be answer candidates belonging to the information type.

For example, the word “100 g” designated by the reference numeral 605 is enclosed in a pair of tags <WEIGHT> and </WEIGHT>. This means that the word belongs to the information type expressing “weight”.

Description after the colon (:) mark after the word “100 g” designated by the reference numeral 605 expresses analysis information of the word “100 g”.

The numerical value “8” designated by the reference numeral 606 expresses the number of bytes contained in the word “100 g”.

Description “86, 100, PT19S” designated by the reference numeral 607 expresses the position of appearance of the word “100 g”, the degree of confidence of the word “100 g” with the information type “weight”, and the position of appearance of the word “100 g” in the video data 104.

The numerical value “86” in the description designated by the reference numeral 607 expresses the position of appearance of the word “100 g” in the speech text data 501 in FIG. 5 (e.g. the position 86 bytes far from the head of the speech text data 501).

The numerical value “100” in the description designated by the reference numeral 607 expresses the degree of confidence of the word “100 g” with the information type “weight” (e.g. 100%).

The value “PT19S” in the description designated by the reference numeral 607 expresses the position (time) of appearance of the word “100 g” in the video data 104 in FIG. 4 (e.g. 19 seconds from the head of the video data 104).

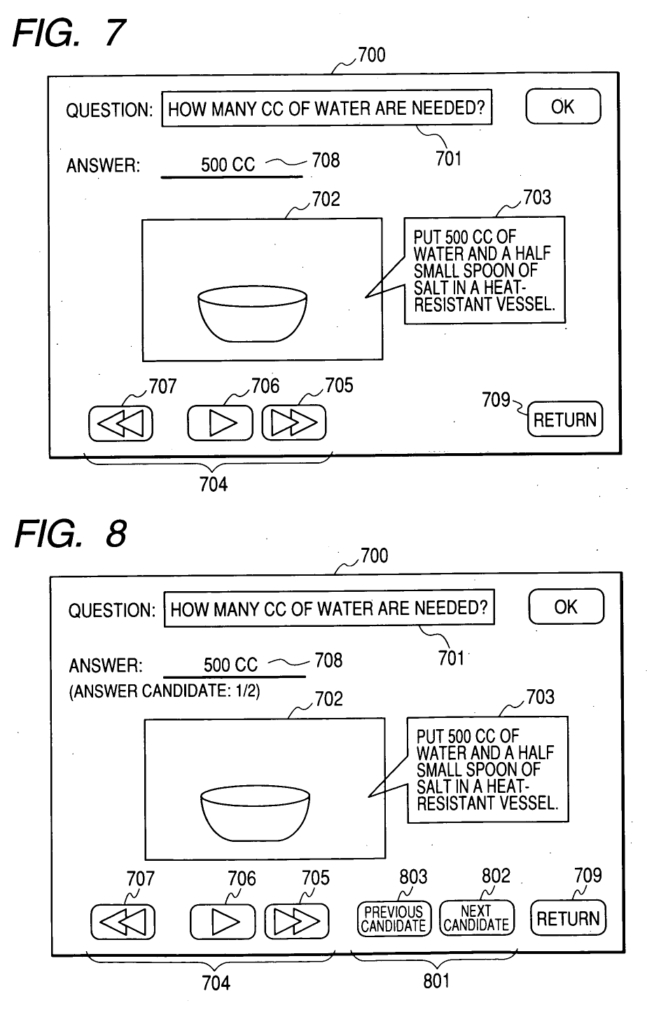

Next, an example of display of multimedia data will be described with reference to FIG. 7.

FIG. 7 is a diagram showing an example of display of multimedia data based on a multimedia data search browsing program 200. Incidentally, this embodiment shows the case where the video data 104 is displayed as multimedia data.

In FIG. 7, a multimedia data search browsing interface 700 includes a user request input portion 701, a video data display portion 702, a meta-information display portion 703, a video data control portion 704, an answer display portion 708, and a button 709. Incidentally, in this embodiment, designation of a playback of the video data 104 etc. is performed by another user interface portion not shown, and the playback of the video data 104 automatically starts with display of a screen.

The user request input portion 701 is a portion in which a user's request can be put. The request is directly input as a test in this portion by the user with use of a keyboard or the like. Or when a voice recognition function is supported by the multimedia data search browsing program 200, a voice recognition result may be displayed. The user request input portion 701 is equivalent to the request acceptance portion 201 in FIG. 2. When the input contents of the user request input portion 701 are confirmed by the user, the text data input in the user request input portion 701 is delivered to the request acceptance portion 201 so that processing starts.

The video data 104 designated by the user or retrieved by the multimedia data reproducing apparatus is reproduced on the video data display portion 702.

Meta-information corresponding to the video data 104 reproduced on the video data display portion 702 is displayed on the meta-information display portion 703.

When the text of the speech portions designated by the reference numerals 401 to 404 in the video data 104 in FIG. 4 and time information of each speech are given as meta-information corresponding to the video data 104, “How to boil spaghetti” (the reference numeral 401 in FIG. 4) is displayed on the meta-information display portion 703 during the playback duration T1-T2 of the video data 104 and “Put 500 cc of water and a half small spoon of salt in a heat-resistant vessel” (the reference numeral 402 in FIG. 4) is displayed during the playback duration T2-T3. Thereafter, the text on the meta-information display portion 703 is switched in accordance with the time information in the meta-information.

Buttons for making operations concerned with the video data 104 are displayed on the video data control portion 704.

A function of starting the playback of the video data 104 on the video data display portion 702 and temporarily stopping the playback is assigned to the button 706.

A function of making the video data 104 reproduced on the video data display portion 702 jump to the start time of the next meta-information is assigned to the button 705. When, for example, the button 705 is pushed down in the condition that the video data 104 in FIG. 4 is reproduced in the duration T2-T3, the playback of the video data 104 starts from the position of the playback time T1 which is the head of the duration T1-T2 as a segment of the meta-information just before the duration T2-T3.

On the other hand, a function of making the video data 104 reproduced on the video data display portion 702 jump to the start time of just before meta-information is assigned to the button 707. When, for example, the button 707 is pushed down in the condition that the video data 104 in FIG. 4 is reproduced in the duration T2-T3, the playback of the video data 104 starts from the position of the playback time T1 which is the head of the duration T1-T2 as a segment of the meta-information just before the duration T2-T3.

When the user inputs a question in the user request input portion 701, a playback of video data displayed as a result of acceptance of the question by the request acceptance portion 201 starts from a position corresponding to an answer regardless of the time information in the meta-information.

A function of returning the playback position of the video data 104 to the position at the point of time when the data input in the user request input portion 701 was accepted by the request acceptance portion 201 is assigned to the button 709. When the user pushes down the button 709, the playback position of the video data 104 at the point of time when the data input in the user request input portion 701 was accepted by the request acceptance portion 201 is read from the playback position storage portion 202 and the playback position of the video data 104 returns to the playback position before the question so that listening of the video data 104 can be continued.

As described above, in accordance with the embodiments of the invention, a place estimated to correspond to the user's request can be specified by retrieval during the playback of multimedia data so that the playback position of the multimedia can be made jump to the specified place and reproduced. Accordingly, the user can save the labor of searching for the place required to be reproduced from the multimedia data, so that usefulness is improved.

(Modified Example of Display of Multimedia Data)

FIG. 8 is a diagram showing another example of display of multimedia data based on the multimedia data search browsing program 200. Incidentally, this embodiment shows the case where voice-including video data is displayed as multimedia data.

In comparison with FIG. 7, the multimedia data search browsing interface 700 in FIG. 8 includes a search result display control portion 801 provided newly. The search result display control portion 801 includes buttons 802 and 803 for performing operations concerned with the display of answers to the request confirmed by the user request input portion 701.

A function of displaying the next answer candidate when there are a plurality of answers is assigned to the button 802.

When the text data input in the user request input portion 701 is delivered to the request acceptance portion 201, one answer candidate or a plurality of answer candidates are obtained through processing in the request analyzing portion 203 and the searching portion 204.

The playback position changing portion 206 delivers information concerned with the plurality of answer candidates obtained by the searching portion 204. That is, (1) the answer candidates, (2) the priority level calculated by the playback position changing portion 205 in accordance with each answer candidate and (3) a correspondence table of position information of the video data 104 corresponding to each answer candidate are delivered to the playback control portion 207.

Upon reception of the three kinds of information from the correspondence table in the playback position changing portion 206, the playback control portion 207 first selects an answer with a high priority level estimated to be an optimum solution. The playback control portion 207 performs display on the multimedia data search browsing interface 700 on the basis of the selected answer and the position information of the video data 104 corresponding to the answer.

For example, the playback control portion 207 displays the optimum solution “500 cc” as an answer on the answer display portion 708 and makes the video data display portion 702 reproduce the video data 104 from the position corresponding to the answer. The playback control portion 207 displays the buttons 802 and 803 on the search result display control portion 801 if there is any other answer candidate. When there is only one candidate as the next candidate on the answer display portion 708, “(candidates: 1/2)” indicating the first candidate (optimum solution) in all the two candidates is displayed on the lower side of the answer display portion 708. Accordingly, the user can find the total number of candidates and the order of the currently displayed candidate in all the candidates. In this manner, whenever the button 802 is pushed down, another answer can be displayed as an answer with a next higher priority level to the currently displayed answer. Whenever the button 803 is pushed down, an answer with a priority level one-level higher than the currently displayed answer can be displayed.

When the button 709 is pushed down after the answer to the request input in the user request input portion 701 can be obtained (the desired video data can be browsed), the video data can return to the video data position which was browsed at the point of time when the user made the request.

According to this configuration, the user can acquire answers from a plurality of answer candidates.

### Second Embodiment

A second embodiment of the invention will be described below with reference to the drawings. The second embodiment is characterized in that analysis information 106 is generated when multimedia is reproduced. The second embodiment of the invention is a modification of the first embodiment. Accordingly, parts the same as those described in the first embodiment are referred to by numerals the same as those in the first embodiment for the sake of omission of description.

The second embodiment shows the case where the video data 104, the meta-information 108 corresponding to the video data 104 and the analysis information 106 are downloaded from the server 102 in FIG. 1 to the client terminal side in advance so that all processes such as searching can be made on the client terminal side.

In FIG. 9, the multimedia data search browsing program 200 includes a request acceptance portion 201, a playback position storage portion 202, a request analyzing portion 203, a searching portion 204, a playback position comparing portion 205, a playback position changing portion 206, a playback control portion 207, and a data analyzing portion 901. As described above, FIG. 9 is different from FIG. 2 in that the data analyzing portion 901 and a meaning analyzing rule 251c are added. The multimedia data search browsing program 200 is executed by a computer. Although computer parts used in the second embodiment of the invention for executing the programs, such as a processor, an ROM, an RAM, etc. are not shown in FIG. 9 because the computer parts are out of the gist of the second embodiment of the invention, a general-purpose computer may be used.

In the second embodiment, the analysis information 106 of the multimedia data 104 generated in advance to be needed by the searching portion 204 is not downloaded from the server 102 side but generated when the multimedia is reproduced. In this embodiment, the data analyzing portion 901 uses the meaning analyzing rule 251c to generate the analysis information 106 when the video data 104 is reproduced.

In FIG. 9, the playback control portion 207 reads the voice-including video data 104 and the meta-information 108 (corresponding to the video data 104) stored in the storage device 110 and controls display, temporary stop, etc. of a playback of the voice-including video data 104 and the meta-information 108 corresponding to the video data.

When the playback of the voice-including video data 104 is started by control of the playback control portion 207, the data analyzing portion 901 generates analysis information 106 by analyzing the reproduced voice-including video data 104 and stores the analysis information 106 in the storage device 110. Specifically, the analysis of the video data 104 is performed as follows.

(1) The speech portion included in the reproduced voice-including video data 104 is recognized as voice to generate speech text data 501 as shown in FIG. 5. In addition to the example shown in FIG. 5, position information (e.g. playback time information) of the speech in the video data 104 is associated with each speech text.

(2) The meaning analyzing rule 251c stored in the storage device 110 is used for analyzing the speech text data 501. In this manner, the analyzed information as designated by the reference numeral 601 in FIG. 6 is generated so as to be added to the analysis information 106.

The analysis information 106 is generated thus. Although this embodiment has shown the case where the speech text data 501 is generated from the voice signal, the embodiments of the invention is not limited thereto and the speech text data may be generated from subtitle data. The subtitle data may be extracted from video in which subtitles are transmitted as video. When text codes are contained as information relevant to the video data, use of text codes is preferred to extraction of subtitle data from video because more correct text codes can be obtained in use of text codes.

The data analyzing portion 901 refers to the analysis information 106 corresponding to the video data 104 so that the video data 104 is not analyzed when a completely analyzed portion has been reproduced yet but the video data 104 is analyzed when a not-completely analyzed portion is being reproduced.

When the user searches the video data 104, a portion to be searched for is generally estimated to be often concerned with the information category interesting to the user. For this reason, a user profile may be stored in the storage device 110 so that the user profile can be used when the video data 104 is analyzed. For example, the information category interesting to the user is described as user profile information. In this case, only a rule belonging to the information category described in the user profile can be downloaded as the meaning analyzing rule 251c. According to this configuration, the number of rules applied to data analysis can be reduced, so that the load imposed on data analysis can be lightened and efficient data analysis can be performed.

User operation history information may be stored in place of the user profile in the storage device 110 so that the number of rules applied to data analysis can be reduced in accordance with the operation history information when the video data 104 is analyzed.

The request analyzing portion 203 analyzes the question sentence text as the user's request accepted by the request acceptance portion 201 and estimates the type of information requested by the question sentence in accordance with the rule stored in the request type analyzing rule 251a and information type analyzing rule 251b in the analyzing rule 251 stored in the storage device 110. When, for example, the question sentence text has the question sentence “When did ZZ XX?”, the required information is estimated to be information of date or time from the expression “When . . . ?”.

The searching portion 204 operates so that answer candidates described with respect to data or time and estimated to be relevant to another keyword (“ZZ” or “did . . . XX”) in the question sentence are extracted from the analysis information 106 in accordance with the information type estimated by the request analyzing portion 203, that is, in accordance with the required information type estimated to be information of date or time.

As described above, the same effect as in the first embodiment can be obtained in the second embodiment of the invention. Moreover, the effect in which the multimedia data reproducing method according to the embodiments of the invention can be used for multimedia data having no analysis information prepared in advance can be obtained.

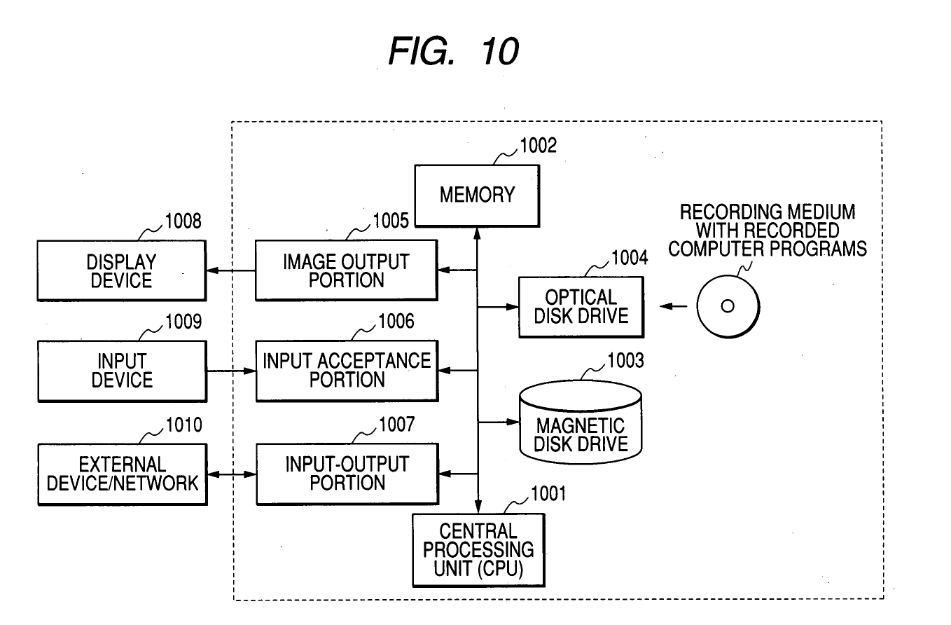

FIG. 10 is a diagram showing an example of hardware in the case where the multimedia data reproducing apparatus according to the embodiments of the invention is achieved by a computer.

The computer includes: a central processing unit 1001 for executing programs; a memory 1002 for storing programs and data processed by the programs; a magnetic disk drive 1003 for storing programs; data to be retrieved and an OS (operating system); and an optical disk drive 1004 for reading and writing programs and data from/into an optical disk.

The computer further includes: an image output portion 1005 serving as an interface for displaying a screen on a display or the like; an input acceptance portion 1006 for accepting an input from a keyboard, a mouse, a touch panel or the like; an input-output portion 1007 serving as an input-output interface (such as a USB (Universal Serial Bus), an audio output terminal, etc.) to an external apparatus. The computer further includes: a display device 1008 such as an LCD, a CRT, a projector, etc.; an input device 1009 such as a keyboard, a mouse, etc.; and an external device 1010 such as a memory card reader, speakers, etc. The external device 1010 may be not an apparatus but a network.

The central processing unit 1001 achieves respective functions shown in FIG. 1 by reading programs from the magnetic disk drive 1003, storing the programs in the memory 1002 and executing the programs. While the programs are executed, a part or all of the data to be searched may be read from the magnetic disk drive 1003 and stored in the memory 1002.

With respect to the basic operation, a search request is received from a user through the input device 1009, and data stored as a subject of search in the magnetic disk drive 1003 and the memory 1002 is searched for in accordance with the search request. A result of the search is displayed on the display device 1008.

The search result may be not only displayed on the display device 1008 but also presented to the user by voice, for example, in the condition that a speaker is connected as the external device 1010. Or the search result may be presented as a printing matter in the condition that a printer is connected as the external device 1010.

Incidentally, the invention is not limited to the aforementioned embodiments and constituent members may be changed in the practical stage to give shape to the the embodiments of the invention without departing from the gist thereof. A plurality of constituent members disclosed in the aforementioned embodiments may be combined suitably to form various embodiments of the invention. For example, several constituent members may be removed from all constituent members disclosed in each embodiment. Constituent members in different embodiments may be combined suitably.

What is claimed is:

1. A multimedia data reproducing apparatus comprising:
a playback control unit that controls reproduction of multimedia data from a plurality of media;
a question acceptance unit that accepts a question from a user;
a playback position storage unit that stores a playback position of the multimedia data reproduced by the playback control unit when the question acceptance unit accepts the question from the user;
an analyzing unit that analyzes the question accepted by the question acceptance unit;
a searching unit that retrieves an answer to the question from analysis information of the multimedia data by using an analysis result of the analyzing unit;
an output unit outputs the answer retrieved by the searching unit to present the answer to the user;
a position comparing unit that compares an answer appearance position of the multimedia data corresponding to the answer retrieved by the searching unit with the playback position stored by the playback position storage unit; and
a playback position changing unit that makes the playback control unit change the playback position of the multimedia data in accordance with a comparison result of the position comparing unit.

2. A multimedia data reproducing apparatus according to claim 1, further comprising:
a display unit that displays the reproduced multimedia data and the answer.

3. A multimedia data reproducing apparatus according to claim 1, further comprising:
an analysis information generating unit that generates the analysis information by analyzing the multimedia data.

4. A multimedia data reproducing apparatus according to claim 3, wherein the analysis information includes:
a meaning attribute which is given to a keyword included in each speech of the multimedia data and which is defined in advance;
a score expressing the degree of confidence in the keyword having the meaning attribute; and
time information for specifying a position where the keyword appears in the multimedia data.

5. A multimedia data reproducing apparatus according to claim 1, wherein the analyzing unit includes an estimation unit that estimates an answer type to be gotten to the question; and
wherein the searching unit retrieves answers of the answer type estimated by the estimation unit.

6. A multimedia data reproducing apparatus according to claims 1, wherein the position comparing unit operates so that a priority level of an answer corresponding to a position nearer to the playback position stored by the playback position storage unit is set to be higher.

7. A multimedia data reproducing apparatus according to claims 1, wherein the position comparing unit calculates the degree of confidence of each of the answers retrieved by the searching unit, and
wherein the position comparing unit calculates the priority level of each of the answers by using the degree of confidence.

8. A multimedia data reproducing apparatus according to claim 1, wherein the position comparing unit operates so that when there are answer candidates, an answer candidate located in a position past and nearest to the playback position stored by the playback position storage unit is selected as an answer to the question.

9. A multimedia data reproducing apparatus according to claim 1, wherein the analyzing unit narrows a number of rules to be applied to data analysis on the basis of at least one user profile information and user operation history information defined in advance.

10. A multimedia data reproducing method comprising:
making a playback control unit control reproduction of multimedia data from a plurality of media;
accepting a question from a user;
storing a playback position of the reproduced multimedia data when the question is accepted from the user;
analyzing the accepted question;
retrieving an answer to the question from analysis information of the multimedia data on the basis of an analysis result;
outputting the retrieved answer to present the answer to the user;
comparing an answer appearance position of the multimedia data corresponding to the retrieved answer with the stored playback position; and
making the playback control unit change the playback position of the multimedia data in accordance with the comparison result.

11. A computer-readable medium for multimedia data reproducing comprising:
making a playback control unit control reproduction of multimedia data from a plurality of media;
accepting a question from a user;
storing a playback position of the reproduced multimedia data when the question is accepted from the user;
analyzing the accepted question;
retrieving an answer to the question from analysis information of the multimedia data on the basis of an analysis result;
outputting the retrieved answer to present the answer to the user;
comparing an answer appearance position of the multimedia data corresponding to the retrieved answer with the stored playback position; and
making the playback control unit change the playback position of the multimedia data in accordance with the comparison result.
